(19) United States
(12) Patent Application Publication
(10) Pub. No.: US 2011/0079352 A1
(43) Pub. Date: Apr. 7, 2011

(54) Flow Controllable B-Stageable Composition

(76) Inventors: Jayesh Shah, Plaistow, NH (US); Jing Fan, Irvine, CA (US)

(21) Appl. No.: 12/905,138

(22) Filed: Oct. 15, 2010

Related U.S. Application Data
(63) Continuation of application No. PCT/US2009/040177, filed on Apr. 10, 2009.
(60) Provisional application No. 61/045,479, filed on Apr. 16, 2008.

(51) Int. Cl. B32B 37/04; B32B 3/10; B32B 5/16; C09J 7/02; B32B 37/00; C09D 163/10

(52) U.S. Cl. 156/275.7; 428/137; 428/327; 428/343; 156/60; 523/428; 523/400

(57) ABSTRACT

A B-stageable dielectric composition for flow control during electronic package assembly is described. The B-stageable composition comprises a resin matrix and flow control agents. The B-stageable composition is particularly useful in laminating substrates for electronic devices and electronic components, where the flow property of the composition must be tightly controlled during the assembly.

### CROSS-REFERENCE TO RELATED APPLICATIONS

This application is a continuation of International Patent Application No. PCT/US2009/040177 filed Apr. 10, 2009, which claims the benefit of U.S. Provisional Patent Application No. 61/045,479 filed Apr. 16, 2008, the contents of both of which are incorporated herein by reference.

### FIELD OF THE INVENTION

The present invention relates to a B-stageable composition, where the flow characteristics of the B-staged composition can be controlled during electronic package assembly.

### BACKGROUND OF THE INVENTION

Conductive and dielectric B-stageable materials are commonly used in electronic assembly as they offer several processing advantages and ease of application over the paste materials. The B-stageable materials can be applied to a substrate and dried (B-staged) to a B-staged film. Alternatively, the B-stageable materials can be applied to a film-carrier and B-staged on the film-carrier. This film can then be cut into specific dimensions and applied to printed circuit board and flexible printed circuit substrates. The B-staged film can later be activated, whereupon the material flows and becomes tacky to attach an electronic component to a substrate.

Assembling an electronic package often requires the B-staged material to undergo subsequent processing steps. The subsequent assembly typically involves filling vias with a conductive material, narrow pitch gold wires bonding and soldering. Because some of the subsequent steps require heat, the B-staged materials can flow out onto other areas of the package.

With the advent of smaller and more sophisticated electronic components, the overall dimension of the assembled package has decreased. It is imperative for the B-staged material to remain in place and not flow out onto other areas of the package during the subsequent assembly steps. Excessive flow of the B-staged material can contaminate other portions of the package, leading to poor functionality and yields of the package.

One method to control the flow has been to use high molecular weight resin as the B-stageable material. However, the use of such high molecular weight resin requires higher activation condition to optimize tack and adhesion. High activation condition (e.g. high temperature and/or pressure) is undesirable since it would lead to higher cost and higher package failures. However, at low activation condition, the high molecular resin based B-staged material is unable to develop tack and results in poor adhesion between a component and a substrate.

Another means to control the flow characteristics has been to add thixotropes (e.g. silica, clay, mica, talc, alumina, among other fillers) in the B-stageable material. Although the thixotropy is improved at room temperature, the flow is not well controlled at subsequent assembly steps, especially at higher temperature. Furthermore, the use of thixotrope can lead to separation or inconsistent bondlines, particularly in narrow bondlines.

Inclusion of spacer beads has been another common means to control the flow of the B-stageable material. Such method requires the spacer beads to remain suspended; however, spacer beads tend to settle, leading to uneven distribution and inconsistent bondlines.

There continues to be a need in the art for a B-stageable composition that provides strong adhesion and flow control during assembly. The current invention addresses this need

### SUMMARY OF THE INVENTION

This invention is a B-stageable dielectric composition, where the addition of flow control agents allows for flow control during the electronic package assembly. The B-stageable composition may be formed as a laminate, and is particularly useful in laminating electronic substrates. Some electronic substrates require the laminate to remain in only specific areas of the substrate, because other areas of the same substrates must be kept as contaminant-free. If the laminate encroaches on the contaminant-free areas of the substrates, it can lead to electronic device failure.

The B-stageable composition can be B-staged as a laminate. Upon activation, or at laminating condition, the laminate exhibits tackiness, allowing the laminate to adhere to a substrate, but does not substantially flow and remains in its place. Even during subsequent assembly steps that require high heat, the laminate does not substantially flow and remains in its place. Hence, the use of the B-stageable composition produces electronic packages with high yields and good functionality.

One embodiment is directed to a B-stageable composition comprising a resin matrix and flow control agents.

In another embodiment, the B-stageable composition comprises a resin matrix, flow control agents, and optionally a catalyst, fillers, defoamers, and adhesion promoters.

In a further embodiment, the B-staged film formed from the B-stageable composition develops tack but does not substantially flow during the package assembly steps.

Yet in another embodiment, the resin matrix of the B-stageable composition comprises a resin, curing agent and a solvent.

In a further embodiment, flow control agent of the B-stageable composition comprises core-shell polymers, block-co-polymers, and mixtures thereof.

Another embodiment of the composition is directed to a B-staged film deposited on a substrate, where the B-staged film exhibits tack but does not substantially flow during the package assembly steps.

In a further embodiment, the substrate contains area/portions with perforations, vias, holes, mask, I/O inputs, and the like, that require substantially no contact with the B-stageable composition during the assembly steps.

Still another embodiment is directed to a method of adhering and/or laminating electronic devices, electronic components and/or electronic substrates using the B-stageable composition. The method comprises applying the B-stageable composition onto a first substrate, B-staging the B-stageable composition to a non-tacky laminate, contacting a second substrate onto the non-tacky laminate and activating the non-tacky laminate, whereby the first substrate comes laminated/bonded to the second substrates.

Another embodiment provides an electronic device manufactured using the B-stageable composition of the invention. Encompassed are thin film solar modules.

### BRIEF DESCRIPTION OF THE DRAWING FIGURES

FIG. 1 is a Olympus microscope SZX-12 DP-70 image, with a five-fold magnification, of a laminated first substrate (with vias) bonded to a second substrate (without any vias) with the B-stageable composition of the invention.

FIG. 2 is a Olympus microscope SZX-12 DP-70 image, with a five-fold magnification, of a laminated first substrate (with vias) bonded to a second substrate (without any vias) with a comparative sample.

### DETAILED DESCRIPTION OF THE INVENTION

The invention relates to a B-stageable composition, in particular the B-stageable composition develops tack but does not substantially flow upon activation nor upon subsequent assembly steps. The invention is particularly useful to laminate electronic substrates where flow property of the laminate must be tightly controlled during package assembly.

The term “B-stage” is herein defined as drying and/or semi-curing, by means of heat and/or air, a paste-like composition into a non-tacky film at room temperature, where it can later be remelted upon activation.

The term “B-staged” is herein defined as a non-tacky film at room temperature, formed by means of B-stage.

The term “activation” is herein defined as pressure, heat and/or radiation to adhere/laminate the B-staged film onto a substrate.

The term “low activation condition” is herein defined as low pressure and low temperature, e.g. less than about 35 psi and less than about 120° C., to adhere/laminate to B-staged film onto a substrate.

The generic term “substrate” is herein defined as semiconductor board, semiconductor chip, flexible substrates, metal foils, surface mount components, resistors, capacitors, and the like.

The term “substantially” is herein defined as less than about 10%.

The invention described herein provides the art with B-stageable compositions, that can be used to attach substrates with electronic components while strictly controlling the flow of the B-staged material during activation and subsequent assembly.

In one embodiment, the B-stageable composition comprises a resin matrix and flow control agents. The B-stageable composition may be deposited onto a first substrate, B-staged to form a film on the first substrate, and upon low activation condition, the film develops tack to adhere to a second substrate but does not substantially flow to contaminate areas where it is undesirable. Even under subsequent assembly conditions, the film remains in place and does not substantially flow.

The B-stageable composition may be applied on both metal and non-metal substrates. Some substrates contain perforations, vias, holes, mask, I/Os, and components; and these areas must be kept free from contaminates. This is important to allow subsequent assembly; additional processing steps, e.g. gold wire bonding, through hole component bonding, solder paste depositing, and the like, may be performed on the substrate's perforations, vias, holes, mask, I/Os and components to form a viable electronic package. Excessive flow of the B-staged material on the substrate would interfere in the latter assembly to result in a package with poor functionality and yields.

The resin matrix is composed of a film forming resin, curing agent and solvent.

Suitable resins include any thermoset or thermoplastic resin that can form a film. Resins with molecular weight ranges of about 1,000 to about 50,000 are preferred for the resin matrix. In various embodiments, these resins are selected from the group consisting of epoxies, phenoxy compounds, polybutadienes [including epoxidized poly(butadienes), maleic poly(butadienes), acrylated poly(butadienes), butadiene-styrene copolymers, and butadiene-acrylonitrile copolymers], maleimide [including bismaleimide], polyimides, acrylates and methacrylates, and cyanate esters, vinyl ethers, thiol-enes, resins that contain carbon to carbon double bonds attached to an aromatic ring and conjugated with the unsaturation in the aromatic ring [such as compounds derived from cinnamyl and styrenic starting compounds], fumarates and maleates. In various other embodiments, these resins include polyamides, benzoxazines, polybenzoxazines, polyether sulfones, siliconized olefins, polyolefins, polyesters, polystyrenes, polycarbonates, polypropylenes, poly(vinyl chloride)s, polyisobutylenes, polyacrylonitriles, poly(vinyl acetate)s, poly(2-vinylpyridine)s, cis-1,4-polyisoprenes, 3,4-polychloroprenes, vinyl copolymers, poly(ethylene oxide)s, poly(ethylene glycol)s, polyformaldehydes, polyacetaldehydes, poly(b-propiolacetone)s, poly(10-decanoate)s, poly(ethylene terephthalate)s, polycaprolactams, poly(11-undecanoamide)s, poly(m-phenylene-terephthalamide)s, poly(tetramethlyene-m-benzenesulfonamide)s, polyester polyarylates, poly(phenylene oxide)s, poly(phenylene sulfide)s, poly(sulfone)s, polyetherketones, polyetherimides, fluorinated polyimides, polyimide siloxanes, poly-isoindolo-quinazolinediones, polythioetherimide poly-phenyl-quinoxalines, polyquinixalones, imide-aryl ether phenylquinoxaline copolymers, polyquinoxalines, polybenzimidazoles, polybenzoxazoles, polynorbornenes, poly(arylene ethers), polysilanes, parylenes, benzocyclobutenes, hydroxyl-(benzoxazole) copolymers and poly(silarylene siloxanes. One or a combination of resins may be used in the resin matrix. The resin is utilized in the range of about 40 to about 99 weight percent based on the dry composition (not including solvent), and preferably from about 50 to about 99 weight percent.

The curing agent may be any conventional or latent curing agent for the thermoset resin. Examples of curing agents include aliphatic and aromatic polyamines, acid anhydrides, the hydrazides derived from polycarboxylic acids, imidazole derivatives (including imidazole adducts, blocked imidazole), imidazole-anhydride adducts, dicyanodiamides, guanidine derivatives, biguanide derivatives, tertiary amines, amine salts, organic metal salts, and, inorganic metal salts and phenols. Preferred curing agents aredicyanodiamide, diaminodicyclomethane, bis(4-amino-3-methylcyclohexyl)methane, diaminodiphenylmethane, diaminodiphenylsulfone, 4,4′-diamino-3,3′-dichlorodiphexylmethane, adipic dihydrazide, sabecic dihydrazide, isophthalic dihydrazide, phthalic anhydride, chlorendic acid anhydride, 2-methylimidazole, 2-phenylimidazole, 2-phenyl-4-methylimidazole, 2-ethyl-4-methylimidazole, 2-undecylimidazole, 1-benzyl-2-methylimidazole, 1-cyanoethyl-2-methylimidazole, 1-cyanoethyl-2-ethyl-4-methylimidazole and the like. The curing agent will be present in about 0.1 to about 30 parts based on reactive resin.

Suitable solvents include esters, alcohols, ethers, acetates, ketones and other common solvents that dissolve the resins in the composition and evaporate during the B-stage process. The solvent will be present in an effective amount to dissolve the resins in the composition and allow good handleability of composition to form a film. The preferred solvents include propylene glycol methyl ether acetate, γ-butyrolactone, propylene glycol methyl ether, propylene glycol-n-propyl ether, di-propylene glycol dimethyl ether, ethylene glycol propylene ether, and mixtures thereof. One skilled in the art may adjust the amount of solvent to the needs of the resin matrix, without undue experimentation. One skilled in the art may also adjust the B-staging condition by varying temperature and time, depending upon the amount of solvent, without undue experimentation.

The resin matrix may further optionally comprise additives such as catalyst or accelerators, fillers, defoamers, and adhesion promoters. In some systems, in addition to curing agents, catalysts or accelerators may be used to optimize the cure rate. Catalysts include, but are not limited to, urea, derivatives (including imidazole adducts, blocked imidazole), imidazole-anhydride adducts, metal napthenates, metal acetylacetonates (chelates), metal octoates, metal acetates, metal halides, metal imidazole complexes, metal amine complexes, triphenylphosphine, alkyl-substituted imidazoles, imidazolium salts, and onium borates. Preferred fillers include silica, clay, talc, alumina, boron nitride, aluminum nitride and calcium carbonate. Exemplary defoamers include foam destroying polysiloxanes, polyacrylates and polyether modified methylalkyl polysiloxane copolymers. Exemplary adhesion promoters are silanes and polyvinyl butyrol. The optional additives may be added up to about 80 weight percent based on the dry composition (not including solvent).

Suitable flow control agents include core-shell polymer and block copolymers. Exemplary core-shell polymers include acrylonitrile butadiene styrene, methacrylate butadiene styrene, polybutadiene, styrene butadiene, siloxane and like, available from Kaneka under the Kane Ace MX series. Other exemplary core shell polymers include acrylonitrile-butadiene-styrene, sold under the tradename BLENDEX-415 (General Electric Company) and methacrylate butadiene styrene, sold under the trade name BTA-753 (Rohm & Haas Company) and E-950 by (Arkema).

Exemplary block copolymers include triblock copolymers designed to produce strong repulsions between the side and middle blocks. Particularly preferred are copolymer of polystyrene, 1,4-polybutadiene, and syndiotactic poly(methyl methacrylate); and with two poly(methyl methacrylate) blocks surrounding a center block of poly(butyl acrylate) (both available as Nanostrength from Arkema). The flow control agents are utilized in the range of about 0.1 to about 30 weight percent based on the dry composition (not including solvent), and preferably from about 1 to about 20 weight percent.

The flow control agents should be evenly dispersed in the resin matrix. Various methods may be utilized to achieve this dispersion, e.g. in situ production, high shear dispersion, cavitation and the like.

In one embodiment, the B-stageable composition may be B-staged as a laminate, and the laminate can be activated to attach a first substrate to a second substrate. The substrates may further contain areas with perforations, vias, holes, mask, I/O inputs, electronic component and the like, where contamination of such areas by the laminate is undesirable.

Hereinafter, a method of using the B-stageable composition in lamination process will be described in detail. The B-stageable composition is applied onto a first substrate, where the substrate contains vias. The substrate is B-staged while air is blown into the vias to keep the B-stageable composition from flowing into them. A non-tacky (at room temperature) laminate is then formed on the first substrate and the vias are laminate-free. A second substrate, without any vias, is applied onto the laminate, and the entire package is subjected to low activation condition. While the laminate becomes tacky, it does not substantially flow and the vias remain substantially laminate-free. The package then undergoes subsequent assembly steps, typically with heat greater than 120° C., and yet the laminate remains in place and does not substantially flow into the vias.

The following examples are for purpose of illustration and not intended to limit the scope of the invention in any manner.

### Examples

The samples in Table 1 were made by the following method: (1) resins were first mixed at a high speed with SpeedMixer (FlackTek); (2) flow control agents, thixotrope, spacer bead, curing agents and catalyst were then added and continued to be mixed at high speed; and (3) the solvent was added until the overall viscosity ranged from about 1,000 to about 20,000 cP.

TABLE 1
Formulations and Comparative Samples

| | Formulation | Formulation | Comparative | Comparative | Comparative | Comparative |
|---|---|---|---|---|---|---|
| Component | 1 (g) | 2 (g) | A (g) | B (g) | C (g) | D (g) |
| Resin A^{a} | 19.70 | | 24.63 | 24.63 | | |
| Resin B^{b} | 35.81 | | 44.76 | 44.76 | | |
| Resin C^{c} | | 60.00 | | | 100.00 | 99.11 |
| Flow Control | 9.22 | | | | | |
| Agent A^{d} | | | | | | |
| Flow Control | | 30.00 | | | | |
| Agent B^{e} | | | | | | |
| Thixotrope^{f} | | | 11.53 | 11.53 | | |
| Spacer bead^{g} | | | | 0.30 | | 0.89 |
| Curing agent^{h} | 1.22 | 0.81 | 1.52 | 1.52 | | |
| Catalystⁱ | 0.56 | 0.41 | 0.70 | 0.70 | | |
| Solvent^{j} | 33.49 | 8.78 | 16.86 | 16.86 | | |

^{a}98-411 (CTBN-epoxy adduct dispersion (75% solids)); Reichhold corporation
^{b}CTBN-epoxy adduct dispersion (55% solids); National Starch & Chemical Company
^{c}High molecular weight phenoxy resin dispersion (30% solids); InChem Corporation
^{d}KaneAce MX 136 (25% styrene-butadiene core-shell dispersion in epoxy resin); Kaneka
^{e}KaneAce MX 965 (25% siloxane core-shell dispersion in epoxy resin); Kaneka
^{f}Cabosil M5 (9% fumed silica dispersed in epoxy); Cabot Corporation
^{g}Spacer bead (2.5 mil diameter); Potters Industries
^{h}Dicyanediamide; Degussa
ⁱSubstituted urea accelerator; CVC Specialty Chemical
^{j}Propylene glycol methyl ethyl acetate; Dow Chemical and Eastern Chemical

The samples prepared according to Table 1 were tested and evaluated to determine their flow characteristics. Each sample was applied onto metal foil substrate that contained 1 mm diameter vias distributed evenly at 1 cm across the substrate roll. Air was blown from the bottom of the vias to keep the sample from flowing into vias during the coating process. The sample was then B-staged at 110° C. for 6 minutes in a convection oven. Upon cooling to room temperature, the samples formed a non-tacky, smooth laminate on the first substrate. A second substrate, without any vias, was applied onto the laminate, and was activated at 85° C. and 30 psi. A final cure at 150° C. for 10 minutes was then applied to the laminated substrates. The vias were examined and the percent of vias filled with the laminate adhesive is reported in Table 2. The use of Formulations 1 and 2 resulted in 0% vias filled with laminate. The use of thixotropes and/or spacer beads resulted in 40% vias with laminate. The use of high molecular resin as the laminate did not flow and failed to adhere the substrates together.

TABLE 2
Evaluation of the Flow characteristics

| | Formulation | Formulation | Comparative | Comparative | Comparative | Comparative |
|---|---|---|---|---|---|---|
| | 1 | 2 | A | B | C | D |
| % of vias | 0 | 0 | 40 | 40 | N/A* | N/A* |
| filled with | | | | | | |
| laminate | | | | | | |

*The substrates did not adhere together because the laminate failed to flow and failed to develop tack at the processing conditions described above.

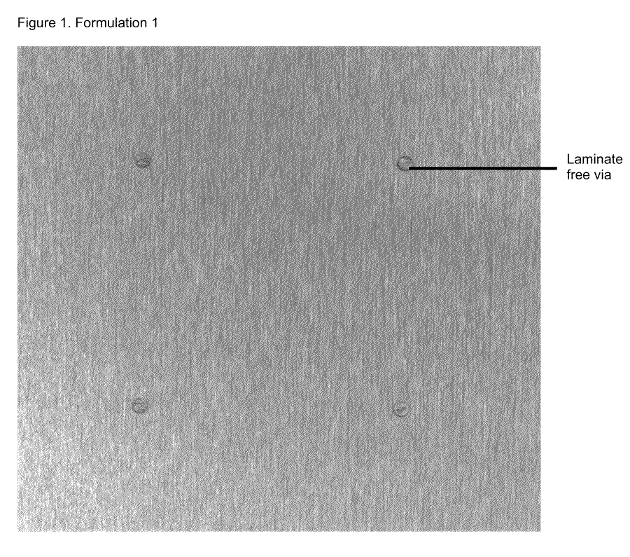

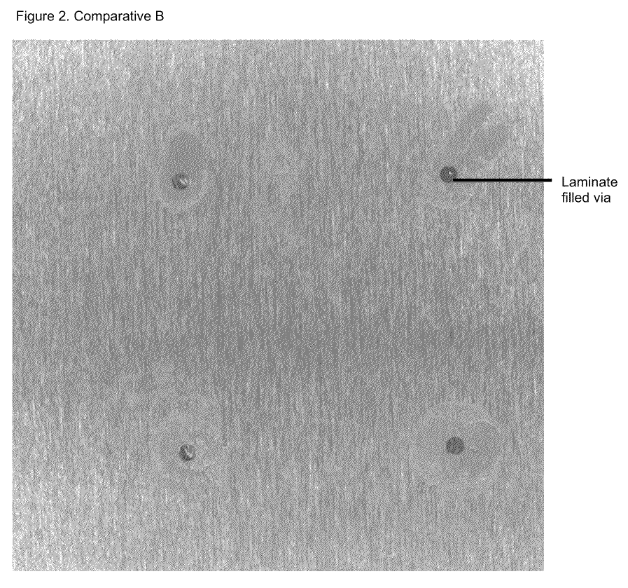

Referring to FIG. 1, the substrates laminated with Formulation 1, the vias are substantially empty. The B-staged laminate did not substantially flow into the vias during lamination nor subsequent curing steps. On the other hand, the use of Comparative B sample filled the vias during lamination and subsequent curing steps (FIG. 2).

The samples were further tested for adhesion of the substrates. Peel strength values, according to ASTM-D standard method, were measured with Instron and the results are listed in Table 3. As shown in Table 3, Formulations 1 and 2 had high peel strength values after B-staging and full cure. Also shown in Table 3, the Comparative C and D resulted in poor adhesion because they did not develop sufficient tack under 85° C. and 30 psi activation conditions.

TABLE 3
Adhesion

| | Formulation | Formulation | Comparative | Comparative | Comparative | Comparative |
|---|---|---|---|---|---|---|
| | 1 | 2 | A | B | C | D |
| Peel Strength | 1.137 | 0.54 | 0.965 | 0.965 | N/A** | N/A** |
| (N/mm)- after | | | | | | |
| B-staging | | | | | | |
| Peel Strength | 1.07 | 1.05 | 1.14 | 1.14 | N/A** | N/A** |
| (N/mm)- after | | | | | | |
| full cure | | | | | | |
| (150° C./30 min) | | | | | | |
| Failure Mode | Cohesive | Cohesive | Cohesive | Cohesive | | |
| after full cure | | | | | | |

*The substrates did not adhere together because the laminate failed to flow and failed to develop tack at the processing conditions described above.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. A laminate composition, wherein said composition comprises a B-staged product of a resin matrix and flow control agents, wherein said B-staged product exhibits tackiness but substantially no flow upon activation.

2. The laminate composition of claim 1, wherein the resin matrix comprises a resin, curing agent and solvent, and wherein the resin is selected from the group consisting of epoxy, phenoxy compounds, polybutadiene epoxy, phenoxy compounds, polybutadiene, maleimide, polyimides, acrylates, methacrylates, cyanate esters, vinyl ethers, thiol-enes, fumarates, maleates and mixtures thereof.

3. The laminate composition of claim 1, wherein the resin matrix comprises a resin, curing agent and solvent, and wherein the curing agent is selected from the group consisting of dicyanediamide, diaminodicyclomethane, bis(4-amino-3-methylcyclohexyl)methane, diaminodiphenylmethane, diaminodiphenylsulfone, 4,4′-diamino-3,3′-dichlorodiphexylmethane, adipic dihydrazide, sabecic dihydrazide, isophthalic dihydrazide, phthalic anhydride, chlorendic acid anhydride, 2-methylimidazole, 2-phenylimidazole, 2-phenyl-4-methylimidazole, 2-ethyl-4-methylimidazole, 2-undecylimidazole, 1-benzyl-2-methylimidazole, 1-cyanoethyl-2-methylimidazole, 1-cyanoethyl-2-ethyl-4-methylimidazole and mixtures thereof.

4. The laminate composition of claim 1, wherein the flow control agents are selected from the group consisting of styrene-butadiene core-shell polymer, siloxane core-shell polymer, acrylonitrile-butadiene-styrene core shell polymer, methacrylate butadiene styrene core shell polymer, polystyrene-1,4-polybutadiene-syndiotactic poly(methyl methacrylate) triblock copolymer, poly(methyl methacrylate)-poly(butyl acrylate)-poly(methyl methacrylate) triblock copolymer and mixtures thereof.

5. A B-staged film deposited on a substrate wherein said film exhibits tackiness and substantially no flow upon activation, wherein said B-staged film is a B-staged product of a resin matrix and flow control agents.

6. The B-staged film deposited on a substrate of claim 5 wherein said substrate contains perforations, vias, holes, mask, I/O inputs, electronic component or mixtures thereof.

7. The B-staged film deposited on a substrate of claim 5, wherein the flow control agent is selected from the group consisting of styrene-butadiene core-shell polymer, siloxane core-shell polymer, acrylonitrile-butadiene-styrene core shell polymer, methacrylate butadiene styrene core shell polymer, polystyrene-1,4-polybutadiene-syndiotactic poly(methyl methacrylate) triblock copolymer, poly(methyl methacrylate)-poly(butyl acrylate)-poly(methyl methacrylate) triblock copolymer and mixtures thereof.

8. A method of laminating a first substrate to a second substrate with a composition comprising a resin matrix and flow control agents; wherein at least one of the substrate contains perforations, vias, holes, mask, I/O inputs, electronic component or mixtures thereof and wherein said method comprises:
(a) applying said composition onto a first substrate;
(b) B-staging said composition into B-staged film;
(c) contacting a second substrate onto said B-staged film; and
(d) activating said B-staged film by radiation, heat, or pressure and mixtures thereof;
whereby, the first substrate becomes bonded to the second substrate, and wherein the flow control agents are selected for the group consisting of styrene-butadiene core-shell polymer, siloxane core-shell polymer, acrylonitrile-butadiene-styrene core shell polymer, methacrylate butadiene styrene core shell polymer, polystyrene-1,4-polybutadiene-syndiotactic poly(methyl methacrylate) triblock copolymer, poly(methyl methacrylate)-poly(butyl acrylate)-poly(methyl methacrylate) triblock copolymer and mixtures thereof.

9. The method according to claim 8, wherein the activation is less than about 120° C. and less than about 50 psi.

10. An article comprising a first substrate bonded to at least a second substrate with the laminant composition of claim 1, wherein at least one of the substrates contains perforations, vias, holes, mask, I/O inputs, electronic component or mixtures thereof.
